(19) United States
(12) Patent Application Publication
(10) Pub. No.: US 2019/0047148 A1
(43) Pub. Date: Feb. 14, 2019

(54) Controlling a Group of Robots

(71) Applicant: KUKA DEUTSCHLAND GMBH, Augsburg (DE)

(72) Inventors: Linda FREMUTH, Augsburg (DE); Andreas HAGENAUER, Friedberg (DE)

(73) Assignee: KUKA Deutschland GmbH, Augsburg (DE)

(21) Appl. No.: 16/073,514

(22) PCT Filed: Jan. 25, 2017
(86) PCT No.: PCT/EP2017/000084

§ 371 Date: Jul. 27, 2018

(30) Foreign Application Priority Data
Jan. 27, 2016 (DE) 10 2016 000 850.4

(51) Int. Cl. B25J 9/16; G05B 19/416

(52) U.S. Cl. CPC B25J 9/1682; B25J 9/1669; G05B 2219/39145; G05B 2219/39144; G05B 19/416

(57) ABSTRACT

The invention relates to a method for controlling a group of robots, comprising a leading robot (10) and at least one following robot (20, 30), which cooperates with the leading robot and moves in accordance with the leading robot, wherein the absolute velocity (v₁₀) of the leading robot and/or the absolute velocity (v_{20abs}) of the following robot is reduced on the basis of a specified limit (vₘₐₓ) such that a mutual relative velocity (V₂₀ᵣₑₗ) is not exceeded and therefore a safety function is not triggered.

### BACKGROUND

The present invention relates to a method, in particular a computer-implemented method, and a system for controlling a group of robots comprising a guide robot and at least one following robot that moves in a manner dependent on the guide robot, and a computer program and a computer program product for the in particular computer-assisted performance of the method.

Monitoring of an actual speed, for example a Cartesian absolute speed of a tool center point (TCP), is known in the case of robots from in-house practice.

It is also already known from in-house practice to reduce a setpoint speed of the robot on the basis of a monitored speed limit such that the actual speed ideally does not breach this monitored speed limit, in particular in order thus to avoid undesired stoppage of the robot as a result of the (triggering of the) monitoring.

On the other hand, it is also known from in-house practice to prescribe a setpoint movement of a robot relative to a reference system, fixed to a robot, of another robot, such that one robot moves in a manner dependent on the other robot, for example in order—as shown in FIG. 1—for one robot to carry out processing operations on a work surface moved by the other robot or the like.

However, in this case, on account of the superimposition of the relative movement of one robot and of the guiding movement of the other robot, this may result in the above-described undesired triggering of monitoring of the absolute speed of one robot.

### SUMMARY

The object of the present invention is to improve the operation of a group of robots comprising a guide robot and at least one following robot that moves in a manner dependent on the guide robot.

This object is achieved by a method having the features of claim 1. Claims 8 to 10 provide a system, a computer program and a computer program product for performing a method described herein under protection. The dependent claims relate to advantageous developments.

According to one embodiment of the present invention, a group of robots comprises a first robot, which is referred to hereinafter, without restricting the generality, as guide robot, and one or more (second, third, etc.) further robots that move in a manner dependent on the guide robot or are configured, in particular programmed, to do so, whose setpoint movement are, in particular in one development, (in each case) prescribed relative to a reference system, fixed to a robot, of the guide robot, and which are therefore referred to hereinafter, without restricting the generality, as following robots. The group of robots consisting of two or more individual robots may also be referred to as robot arrangement.

In one development, the guide robot may be a master robot whose setpoint movement is independent, or is prescribed independently, of a movement of another robot of the group.

In another development, the guide robot may for its part, at the same time, in turn be a following robot that moves in a manner dependent on another (even) higher-ranking guide robot, or is configured, in particular programmed, to do so, and whose setpoint movement is in particular prescribed relative to a reference system, fixed to a robot, of another (even) higher-ranking guide robot. Accordingly, conversely, in one development a following robot may for its part be a guide robot for other (even) lower-ranking following robots that move in a manner dependent on this guide robot or are configured, in particular programmed, to do so, and whose setpoint movement are in particular (in each case) prescribed relative to a reference system, fixed to a robot, of this robot.

In one embodiment, the guide robot or its controller transmits, to the following robot(s) or their controllers, its (respective) pose and/or movement, in particular its current and/or future setpoint and/or actual pose and/or movement, or is configured to do so, so that said following robots (are able to) move in a manner dependent on the guide robot, in particular on its pose or (guide) movement, in particular are able to determine their in particular absolute setpoint pose and/or movement or perform their prescribed relative movement on the basis of this pose or (guide) movement and of the setpoint movement prescribed relative to the reference system, fixed to a robot, of the guide robot.

In this case, a setpoint movement of a following robot, which setpoint movement is prescribed relative to the reference system, fixed to a robot, of the guide robot, may in particular also be at least temporarily a standstill or the following robot may at least temporarily follow the guide robot rigidly, so to speak. In one embodiment, the following robot(s), during operation of the group of robots, perform(s) the movement(s) that are prescribed relative to the reference system, fixed to a robot, of the guide robot, or move(s) in a prescribed way in a manner dependent on a (guiding) movement of the guide robot.

In one embodiment, one or more robots of the group of robots have (in each case) at least six, in particular at least seven, joints or axles (of movement) and in particular electromotive drives for these axles. Robots of the group of robots may in particular be industrial and/or articulated-arm robots.

According to one embodiment of the present invention, a speed of the guide robot, in particular a current and/or absolute or relative and/or setpoint or actual speed of the guide robot, is reduced (as necessary) on the basis of a prescribed limit of a speed, in particular an absolute or relative and/or actual or setpoint speed, of at least one following robot, in one development on the basis of prescribed limits of speeds, in particular absolute or relative and/or actual or setpoint speeds, of two or more following robots of the group of robots.

Additionally or alternatively, according to one embodiment of the present invention, a speed, in particular a current and/or relative or absolute and/or setpoint or actual speed, of a or of the following robot, in one development speeds, in particular current and/or relative or absolute and/or setpoint or actual speeds, of two or more following robots of the group of robots, is (in each case) reduced on the basis of a or of the prescribed limit of a or of the speed, in particular a or the absolute or relative and/or actual or setpoint speed, of the (respective) following robot. In this case it is possible for the reduction in the speed of a following robot to be brought about through direct communication between this following robot and another following robot. Alternatively or additionally, it is possible for the reduction in the speed of a following robot to be brought about through indirect communication between this following robot and another following robot, the indirect communication taking place via the guide robot.

As a result of this, in one embodiment, the likelihood of undesired triggering of monitoring of a speed of one or more following robots is advantageously able to be reduced. In particular, the triggering of safety monitoring of one of the robots contained in the group of robots is able to be avoided, for example in the case where all of the robots are not to exceed a maximum absolute speed, in particular during programming and during testing of the program sequence, during which preferably an absolute speed of about 250 mm/s is not to be exceeded, in order to avoid injury to people in the working space of one of the robots.

One or more speeds mentioned here may respectively comprise, in particular be, in particular a Cartesian speed of a reference fixed to a robot, in particular of the TCP, of the respective robot or components of this speed.

Additionally or alternatively, one or more of the speeds mentioned here may respectively comprise, in particular be, in particular one or more joint or axle speeds of the respective robot.

A current speed may in particular be a speed in a (current or next to be performed) control cycle, in particular IPO cycle. Correspondingly, a previous speed may be in particular a speed in a preceding control cycle, in particular IPO cycle, in particular a speed in a directly preceding or previous cycle or else in another preceding or previous cycle.

An absolute speed may be a speed of a reference fixed to a robot with respect to an, in particular fixed, environment of the (group of) robot(s). This means that the absolute speed is able to be ascertained on the basis of the movement of the TCP in the fixed coordinate system of the robot arrangement.

A relative speed may be in particular a speed, in particular of a reference, fixed to a robot, of a robot, in particular of a following robot, with respect to or relative to a reference, fixed to a robot, or to a reference system, fixed to a robot, of another robot, in particular of a guide robot, in particular a or the speed of the setpoint movement of the following robot, which setpoint movement is prescribed relative to the reference system, fixed to a robot, of the guide robot, or of the movement of the following robot relative to the guide robot. This means that the relative speed is able to be ascertained on the basis of the movement of the TCP of the following robot in the coordinate system of the TCP of the guide robot, which coordinate system is able to move with respect to the fixed coordinate system of the robot arrangement, in particular with the TCP of the guide robot as origin.

A joint speed of a robot may likewise be an absolute or relative speed within the meaning of the present invention. A relative joint speed of a following robot may in particular comprise that component of the joint speed, in particular be that component of the joint speed, that corresponds to the setpoint movement that is prescribed relative to the reference system, fixed to a robot, of the guide robot.

A setpoint speed may be in particular a commanded or prescribed, in particular programmed, speed or a speed that the robot seeks to attain, and an actual speed may be in particular an actual, in particular detected, in particular measured, speed of the robot.

A reduction as necessary is understood here in particular to mean a reduction when a condition is present or complied with, in particular a reduction in any case or only if, without a reduction, a prescribed limit is exceeded or this is predicted.

In one embodiment, in particular a current absolute or relative setpoint speed of the guide robot and additionally (in each case) a current relative setpoint speed or speed of the setpoint movement of the following robot(s), which setpoint movement is prescribed relative to the reference system, fixed to a robot, of the guide robot, is reduced (as necessary) on the basis of the prescribed limit(s) of the absolute setpoint speed of the following robot(s).

If, according to one embodiment of the present invention, a speed, in particular a current absolute or relative setpoint speed, of the guide robot, is reduced—at least as necessary—on the basis of prescribed limits of speeds, in particular absolute actual speeds, of two or more following robots of the group of robots, then, in one development, the speed of the guide robot is reduced to the lowest speed of the speeds that result on the basis of the respectively prescribed limits of the speed of the individual following robots, for example in that a method described here is performed in each case in pairs for the guide robots and one of the following robots and then the greatest reduction determined thereby is implemented for the guide robot. In other words, a reduction in the speed(s) on the basis of the smallest reduction factor, where the reduction factor is greater than zero and less than or equal to 1.

In one embodiment, a or the (prescribed) limit of a speed of a following robot is able to be prescribed or is prescribed, in particular variably or adjustably, in a manner dependent on a speed limit of this following robot, which speed limit is in particular safe and/or monitored by a safety means, in particular such that it is in particular always lower than the monitored speed limit itself. In one development, the prescribed limit may depend linearly on the monitored speed limit, in particular be equal to a product of the monitored speed limit and a safety factor that preferably lies between about 0.7 and about 0.95, more preferably lies between about 0.75 and about 0.9 and in particular is about 0.8. Accordingly, in one embodiment, the prescribed limit is at least 70% and/or at most 95% of a speed limit that is in particular safe and/or monitored by a safety means.

As a result of this, in particular in spite of or even including approximation errors or the like, the monitored speed limit is advantageously able to be complied with relatively reliably, and the likelihood of triggering of monitoring of this speed limit is able to be reduced.

In one embodiment, the speed of the guide robot and/or of the following robot(s) is reduced on the basis of a prediction of a speed, in particular of a current absolute setpoint speed, of the corresponding following robot, the prediction being based, in one development, on one or more previous speeds, in particular absolute setpoint or actual speeds, of this following robot.

As explained in the introduction, an absolute speed of a following robot is obtained by superimposing its relative movement and the absolute movement of the guide robot. Therefore, it may be difficult to ascertain an absolute speed of the following robot. Through a prediction on the basis of previous or past speeds, it is advantageously possible to estimate in particular an absolute speed of a following robot and use it as a basis for reducing the speed(s). A predicted speed is in this case also referred to as a prediction (of this speed).

In one development, the speed of the guide robot and/or of the following robot(s) is reduced on the basis of a comparison, in particular quotient, of the prescribed limit of the speed of the respective following robot and of its predicted speed, in particular on the basis of an adjustment factor that is in particular linearly dependent on the prescribed limit of the speed of the respective following robot and its predicted speed.

In one embodiment, the speed of the guide robot and/or of the following robot(s) is additionally (also) reduced on the basis of a speed reduction prescribed by a user, in particular on the basis of the stricter or greater speed reduction. As a result of this, in one embodiment, a speed reduction prescribed by a user may additionally (also) be complied with, in particular even when the prescribed limit of the speed of the following robot(s) alone would allow a higher speed.

In one development, the speed reduction prescribed by a user is limited such that the speed of the guide robot or following robot is reduced in any case and is not increased in any case, in particular even when the prescribed limit of the speed of the following robot(s) alone would allow a higher speed.

In one embodiment, the speed of the guide robot and/or of the following robot(s) is reduced in a filtered manner, in particular in that a reduction factor for the speed is filtered over several previous control cycles, in particular IPO cycles. In this way, it is advantageously possible to reduce fluctuations in the speed.

In one embodiment, the method comprises one or more of the following steps:
predicting a speed, in particular a current and/or absolute or relative and/or setpoint or actual speed, of one or more following robots, in particular on the basis of one or more previous speeds, in particular absolute or relative and/or actual or setpoint speeds, of the (respective) following robot, in particular by in particular linear approximation or extrapolation;
determining an adjustment factor of one or more following robots on the basis of a or of the in particular predicted speed and/or of a or of the prescribed limit of a speed of the respective following robot, in particular in a manner dependent on a quotient of the prescribed limit and the in particular predicted speed;
determining, in particular filtering, a reduction factor, in particular a so-called override (factor), (of a or of the speed) of the guide robot on the basis of a or of the determined adjustment factor of one or more following robots, a previous reduction factor of the guide robot and/or a speed reduction prescribed by a user, in particular in the form of a reduction factor prescribed by a user, of the guide robot, in particular by multiplying a previous reduction factor of the guide robot by the respective adjustment factor and/or selecting the strongest or strictest reduction factor;
determining, in particular filtering, a reduction factor, in particular a so-called override (factor), (of a or of the speed) of at least one following robot on the basis at least of a or of the determined adjustment factor of the following robot, a previous reduction factor of the following robot and/or a speed reduction prescribed by a user, in particular in the form of a reduction factor prescribed by a user, of the following robot, in particular by multiplying a previous reduction factor of the following robot by the adjustment factor and/or selecting the smallest reduction factor, the reduction factor being greater than zero and less than or equal to one; and/or
transmitting a or the adjustment factor of one or more following robots to a controller of the guide robot, such that said controller is able to determine its reduction factor on the basis of this determined adjustment factor.

According to one embodiment, a system is configured, in particular in terms of hardware and/or software and in particular in terms of programming, to perform a method described herein and/or comprises:

means for reducing a or the speed of the guide robot and/or of the following robot(s) on the basis of a or the predefined limit of a speed of the (respective) following robot, in particular for reducing the speed of the guide robot on the basis of the prescribed limits of speeds of at least two following robots; and/or

means for prescribing the limit of a speed of at least one following robot in a manner dependent on a or the monitored speed limit of this following robot, in particular such that it is lower than the monitored speed limit; and/or

means for reducing the speed of the guide robot and/or of at least one following robot on the basis of a or of the prediction, which is based in particular on at least one previous speed of the following robot, of a speed of the at least one following robot; and/or

means for reducing the speed of the guide robot and/or at least one following robot additionally on the basis of a or of the speed reduction prescribed by a user; and/or

means for the filtered reduction of the setpoint speed of the guide robot and/or of at least one following robot; and/or

means for predicting a or the speed of at least one following robot, in particular on the basis of at least one previous speed of this following robot; and/or

means for determining an or the adjustment factor of at least one following robot on the basis of a or the in particular predicted speed and/or of a or the predefined limit of a speed of the following robot; and/or

means for determining, in particular filtering, a or the reduction factor of the guide robot and/or of at least one following robot on the basis of at least one or of the determined adjustment factor, of a or of the previous reduction factor and/or of a or of the speed reduction prescribed by a user, and/or

means for transmitting an or the adjustment factor of at least one following robot to a or the controller of the guide robot.

A means within the meaning of the present invention may be embodied as hardware and/or as software, in particular an in particular digital processing unit, in particular microprocessor unit (CPU), preferably connected to a storage system and/or bus system in terms of data and signals, and/or comprise one or more programs or program modules. The CPU may be configured to process commands that are implemented as a program stored in a storage system, to acquire input signals from a data bus and/or to deliver output signals to a data bus. A storage system may comprise one or more, in particular different, storage media, in particular optical, magnetic, solid-state and/or other non-volatile media. The program may be designed such that it embodies the methods described here or is capable of executing them, such that the CPU is able to perform the steps of such methods and is thus able to control the group of robots.

In one embodiment, one or more steps of the method are fully or partly automated and/or executed or performed during operation of the group of robots, in particular during execution of the prescribed, in particular stored, setpoint movements, in particular by the system, its means and the computer program.

Control is also understood in particular to mean regulation in the present case.

In one embodiment, the speed of the guide robot and/or of the following robot(s) is reduced by multiplying a prescribed, in particular current and/or absolute or relative, setpoint speed by the corresponding current reduction or override factor.

### BRIEF DESCRIPTION OF THE DRAWINGS

Further advantages and features become apparent from the dependent claims and the exemplary embodiments. To this end, and partially schematically:

FIG. 1 shows a group of robots and a system for controlling the group of robots according to one embodiment of the present invention; and

FIG. 2 shows a method for controlling the group of robots according to one embodiment of the present invention.

### DETAILED DESCRIPTION

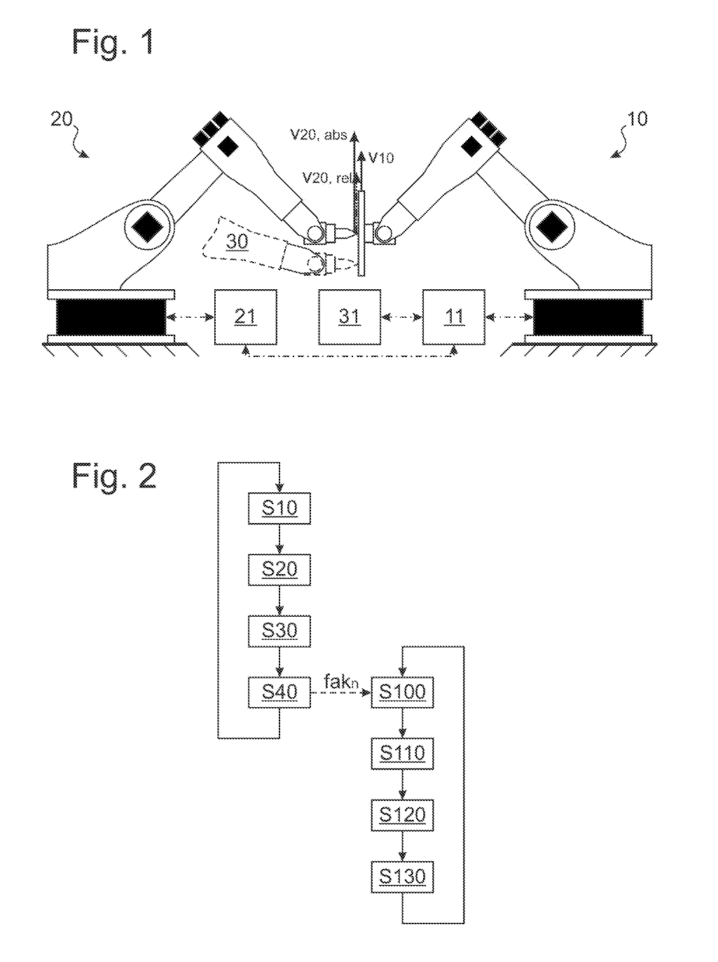

FIG. 1 shows a group of robots comprising a guide robot 10 and a following robot 20. A further following robot 30 is indicated only partially and in dashed lines.

The guide robot 10 guides a tool vertically upward, as indicated in FIG. 1 by a movement arrow v₁₀.

For the following robot 20, as indicated in FIG. 1 by a movement arrow v_{20,rel}, a setpoint movement relative to a reference system, fixed to a robot, of the guide robot 10 is prescribed, the coordinate axes of which lie by way of example in the plane of the tool or are perpendicular thereto. Correspondingly, the following robot 20 moves, within the meaning of the present invention, in a manner dependent on the guide robot 10.

The absolute speed of the following robot 20, as indicated in FIG. 1 by a movement arrow v_{20,abs}, is thus obtained by superimposing the absolute speed of the guide robot 10 and the movement of the following robot 20 relative thereto. The same applies analogously to the further following robot 30.

A system for controlling this group of robots, according to one embodiment of the present invention, comprises robot controllers 11, 21 and 31 for the robots 10, 20 and 30, respectively, which controllers communicate with one another for example via a bus. Said system performs a method, explained below with reference to FIG. 2, for controlling the group of robots according to one embodiment of the present invention.

In a first step S10, the controllers 21, 31 predict, for the associated following robot 20 or 30, in each case a current setpoint speed v_{P,n} for the current control cycle n on the basis of the directly previous actual speed vₙ₋₁ and of the setpoint speed vₙ₋₂ preceding this one of the two preceding control cycles n−1 and n−2 by linear extrapolation

v_{P,n}=2×vₙ₋₁−vₙ₋₂ (1)

Instead of the setpoint speed, the actual speed of the last control cycle may also be used as an alternative. In this case, the speeds may in each case be in particular absolute Cartesian speeds of the TCP or else joint (angle) speeds of the corresponding robot.

Next, in a step S20, the controllers 21, 31 in each case determine, for the associated robot 20 or 30, an adjustment factor fakₙ on the basis of this predicted current setpoint speed v_{P,n} and of a prescribed limit vₘₐₓ of a setpoint speed or actual speed of the following robot, which is obtained by multiplying a monitored speed limit v_{max, 0} by a safety factor of for example 0.8, in accordance with:

fakₙ=vₘₐₓ/v_{P,n}=(0.8×v_{max,0})/v_{P,n} (2)

A factor of less than one may alternatively be selected as safety factor, typically a factor between about 0.7 and about 0.95. In this case, the (prescribed limits of the) setpoint speeds or actual speeds may correspondingly each in turn in particular be (prescribed limits of the) absolute Cartesian speeds of the TCP or else joint (angle) speeds of the corresponding robot.

In a step S30, the controllers 21, 31 then determine, respectively for the associated robot 20 or 30, a current reduction factor in the form of a so-called override (factor) Ovₙ for the current control cycle on the basis of this adjustment factor fakₙ, of a previous reduction or override (factor) Ovₙ₋₁ for the preceding control cycle n−1 and of a speed reduction prescribed by a user in the form of an override (factor) Ov_{reg} prescribed by a user in accordance with:

Ovₙ=min{Ov_{reg},fakₙ×Ovₙ₋₁} (3)

The override factor Ov_{reg} prescribed by a user may be prescribed to be between 0 and 1 or 0 and 100%.

Through the minimum rule min{ } that delivers the smallest value, an override factor of at most Ovₙ=1 or 100% is thus determined in each case. Correspondingly, undershooting of the prescribed limit vₘₐₓ by the predicted setpoint speed v_{P,n} also does not lead to an increase in the override (factor) Ovₙ.

By multiplying the previous reduction or override (factor) Ovₙ₋₁ by the current adjustment factor fakₙ, the present override (factor), corresponding to the prediction of the setpoint speed and the comparison thereof with the monitored speed limit v_{max, 0} or prescribed limit vₘₐₓ, is updated or adjusted so as to obtain adaptive adjustment of the override factors of the following robots 20, 30.

In a step S40, the controllers 21, 31 transmit the respective adjustment factor fakₙ to the controller 11 of the guide robot 10, reduce the setpoint speed of the relative movement of the respective following robot 20, 30, in particular a corresponding joint (angle) or relative Cartesian setpoint speed, with the or by the corresponding current override (factor) Ovₙ, and then return to step S10 in order to perform the sequence S10-S40 described above again for the next control cycle.

In a step S100, the controller 11 acquires the adjustment factors fakₙ of the following robots 20, 30 for the current control cycle.

In a step S110, the controller 11 determines a reduction or override (factor) Ov_{M,n}, in a manner known per se that is therefore not described in more detail here, such that the absolute setpoint speed of the guide robot 10 remains below a monitored speed limit v_{max, 0}.

In addition, a user is in turn also able to prescribe a reduction or override (factor) Ov_{reg} for the guide robot 10.

In a step S120, the controller 11 determines, on the basis of the adjustment factors fakₙ₋₁ of the following robots 20, 30 for the previous control cycle n−1, of the previous reduction or override (factor) Ovₙ₋₂ of the guide robot 10 for the cycle before the previous control cycle n−2, of the reduction or override (factor) Ov_{reg} prescribed by a user and of the reduction or override (factor) Ov_{M,n} for the guide robot 10, the reduction or override (factor) Ovₙ of the guide robot 10 for the current control cycle in accordance with:

Ovₙ=min{Ov_{reg},Ov_{M,n},fakₙ₋₁×Ovₙ₋₂} (4)

In this case, the term fakₙ₋₁×Ovₙ₋₂ collectively denotes both products of the reduction factor Ovₙ₋₂ and the respective adjustment factor fakₙ₋₁ of the following robots 20 and 30.

The current reduction or override (factor) Ovₙ for the guide robot 10 is thus obtained as the smallest value of the reduction or override (factor) Ov_{reg} prescribed by a user for the guide robot 10, the reduction or override (factor) Ov_{M,n} for complying with the monitored speed limit for the guide robot 10 and its previous reduction or override (factor) Ovₙ₋₂ adjusted according to the adjustment factors fakₙ₋₁ of the following robots 20, 30.

In a step S130, the controller 11 reduces the current absolute setpoint speed of the guide robot 10, in particular its joint (angle) or absolute Cartesian setpoint speed, by this current override factor Ovₙ and then returns to step S100 in order to perform the sequence S100-S130 described above again for the next control cycle.

By way of the reduction as necessary of the setpoint speeds of both the following robot and the guide robot, the likelihood of the following robot 20, 30 triggering monitoring of its Cartesian or joint (angle) actual speeds is thus advantageously able to be reduced.

In this case, by way of the adjustment factor fakₙ, in each case the speed of the relative movement of the corresponding following robot, on the one hand, and—with delaying of a control cycle (cf. fakₙ₋₁), also the speed of the guiding movement of the guide robot 10, on the other hand, is reduced.

Although exemplary embodiments have been given in the above description, it is pointed out that numerous modifications are possible.

The guide robot 10 in the exemplary embodiment is thus a master robot of the group of robots 10, 20, 30. As explained above, in one modification, it may likewise be a following robot or slave of an (even) higher-ranking guide robot, its speed then being able to be reduced as explained above for the following robots 20, 30. The prescribed limits vₘₐₓ of the following robots 20, 30 then possibly also have an effect, through the corresponding reduction in the speed of the robot 10, on the movement of such an even higher-ranking guide robot.

It is furthermore pointed out that the exemplary embodiments are merely examples that are not intended to restrict the scope of protection, the applications and the structure in any way. On the contrary, the preceding description gives a person skilled in the art a guideline for implementing at least one exemplary embodiment, with diverse amendments, in particular with regard to the function and arrangement of the components that are described, being able to be made without departing from the scope of protection as results from the claims and these equivalent combinations of features.

### LIST OF REFERENCE SIGNS

10 guide robot
20, 30 following robot
11, 21, 31 (robot) controller (system, means)
v₁₀ prescribed absolute guide movement/speed of the guide robot
v_{20, rel} prescribed relative movement/speed of the following robot 20
v_{20, abs} absolute movement/speed of the following robot 20
fakₙ adjustment factor

1. A method for controlling a group of robots comprising a guide robot (10) and at least one following robot (20, 30) that moves in a manner dependent on the guide robot, wherein a speed of the guide robot and/or following robot is reduced (S40, S130) on the basis of a prescribed limit (vₘₐₓ) of a speed of the following robot.

2. The method as claimed in claim 1, characterized in that the group of robots comprises at least two following robots (20, 30) whose setpoint movements are in each case prescribed relative to a reference system, fixed to a robot, of the guide robot, wherein the speed of the guide robot is reduced on the basis of prescribed limits (vₘₐₓ) of speeds of these following robots.

3. The method as claimed in claim 1, characterized in that the limit (vₘₐₓ) of a speed of at least one following robot is able to be prescribed in a manner dependent on a monitored speed limit (v_{max, 0}) of this following robot, in particular such that it is lower than the monitored speed limit.

4. The method as claimed in claim 1, characterized in that the speed of the guide robot and/or of at least one following robot is reduced on the basis of a prediction (v_{P,n}), which is based in particular on at least one previous speed (vₙ₋₁, vₙ₋₂) of the following robot, of a speed of the at least one following robot.

5. The method as claimed in claim 1, characterized in that the speed of the guide robot and/or of at least one following robot is additionally reduced on the basis of a speed reduction (Ov_{reg}) that is prescribed by a user.

6. The method as claimed in claim 1, characterized in that the speed of the guide robot and/or of at least one following robot is reduced in a filtered manner.

7. The method as claimed in claim 1, characterized by at least one of the steps:
predicting (S10) a speed (v_{P,n}) of at least one following robot, in particular on the basis of at least one previous speed (vₙ₋₁, vₙ₋₂) of this following robot;
determining (S20) an adjustment factor (fakₙ) of at least one following robot on the basis of an in particular predicted speed (v_{P,n}) and/or of a prescribed limit (vₘₐₓ) of a speed of the following robot;
determining (S30, S120), in particular filtering, a reduction factor (Ovₙ) of the guide robot and/or of at least one following robot on the basis of at least one determined adjustment factor (fakₙ), of a previous reduction factor (Ovₙ₋₁, Ovₙ₋₂) and/or of a speed reduction (Ov_{reg}) prescribed by a user; and/or
transmitting (S40) an adjustment factor (fakₙ) of at least one following robot to a controller (11) of the guide robot.

8. An arrangement containing at least two controllers (11, 21, 31) for controlling a group of robots comprising a guide robot (10) and at least one following robot (20, 30) that moves in a manner dependent on the guide robot, wherein the arrangement is configured to perform a method as claimed in one of the preceding claims and/or comprises:
means for reducing a speed of the guide robot and/or following robot on the basis of a prescribed limit (vₘₐₓ) of a speed of the following robot, in particular for reducing the speed of the guide robot on the basis of prescribed limits (vₘₐₓ) of speeds of at least two following robots, and/or
means for prescribing the limit (vₘₐₓ) of a speed of at least one following robot in a manner dependent on a monitored speed limit (v_{max, 0}) of this following robot, in particular such that it is lower than the monitored speed limit; and/or
means for reducing the speed of the guide robot and/or of at least one following robot on the basis of a prediction (v_{P,n}), which is based in particular on at least one previous speed (vₙ₋₁, vₙ₋₂) of the following robot, of a speed of the at least one following robot; and/or
means for reducing the speed of the guide robot and/or of at least one following robot additionally on the basis of a speed reduction (Ov_{reg}) prescribed by a user; and/or
means for the filtered reduction of the setpoint speed of the guide robot and/or of at least one following robot; and/or
means for predicting a speed (v_{P,n}) of at least one following robot, in particular on the basis of at least one previous speed (vₙ₋₁, vₙ₋₂) of this following robot; and/or
means for determining an adjustment factor (fakₙ) of at least one following robot on the basis of an in particular predicted speed (v_{P,n}) and/or of a prescribed limit (vₘₐₓ) of a speed of the following robot; and/or
means for determining, in particular filtering, a reduction factor (Ovₙ) of the guide robot and/or of at least one following robot on the basis of at least one determined adjustment factor (fakₙ), of a previous reduction factor (Ovₙ₋₁, Ovₙ₋₂) and/or of a speed reduction (Ov_{reg}) prescribed by a user; and/or
means for transmitting an adjustment factor (fakₙ) of at least one following robot to a controller (11) of the guide robot.

9. A computer program that, when it is loaded onto and executed on at least one controller (11, 12, 13) for controlling a group of robots, is designed to perform a method as claimed in claim 1.

10. A computer program product comprising a program code stored on a computer-readable medium for performing a method as claimed in claim 1.
